(19) United States
(12) Patent Application Publication
(10) Pub. No.: US 2024/0318467 A1
(43) Pub. Date: Sep. 26, 2024

(54) SLIDING DOOR LOCKING SYSTEM

(71) Applicant: Charles T. Howard, Chaplin, KY (US)

(72) Inventor: Charles T. Howard, Chaplin, KY (US)

(21) Appl. No.: 18/616,131

(22) Filed: Mar. 25, 2024

Related U.S. Application Data
(60) Provisional application No. 63/454,196, filed on Mar. 23, 2023.

(51) Int. Cl. E05B 65/08; E06B 3/46

(52) U.S. Cl. CPC E05B 65/0835; E06B 3/4636

(57) ABSTRACT

A locking system for a sliding door which inhibits both the sliding travel and pivoting action of the door and prevents an intruder from unlocking the sliding door from the inside of the structure.

### CROSS REFERENCES TO RELATED APPLICATIONS

This application claims priority from U.S. Provisional Application Ser. No. 63/454,196 filed on Mar. 23, 2023 which is incorporated by reference in its entirety.

### FIELD OF INVENTION

The present invention relates to door locks and, more specifically, a door lock assembly for barn doors and other surface-mounted sliding doors.

### BACKGROUND OF THE INVENTION

Surface mounted sliding doors are an increasingly popular choice for many applications, especially for barns. These doors typically hang and slide along a track mounted to the exterior of a building structure above the door frame. The track extends at least an additional door-width beyond the door frame so that the door may slide along the track and provide unobstructed access to the contents within the building. In many cases, the bottom of the door is not attached to a track, and thus, the top of the door is able to pivot about the top track such that the bottom of the door swings outwardly.

The ability of the bottom of the door to swing outwardly away from the structure presents a security risk, as the gap between the pivoted door and building may provide enough space for an intruder to enter the building. Additionally, pivoting the door may cause the door to derail, causing inconvenience or potential injury. Attempts have been made to prevent both sliding and pivoting of the doors by securing the doors from the inside of the structure using either latches or chains to hold the sliding doors in place. However, if an intruder enters the barn through a window or access door, there is no means by which to prevent the intruder from unlatching or unchaining the sliding door and opening the structure to remove the large equipment inside.

U.S. Pat. No. 4,098,300 to Edeus discloses a jamb latch for a sliding door utilizing a pivotably mounted operating arm which in one position is used to pull the door tightly against the jamb and to latch the door in place and which in a second position extends across the edge of the door to hold it in an open position. While this device does inhibit sliding and pivoting, it cannot prevent the unlatching of the door by an intruder who has gained access through other points of entry. Further, the device cannot be unfastened from the exterior of the building.

U.S. Pat. No. 11,082,840 to Colligan discloses a sliding door locking system having a lock housing mounted in the sliding door, the lock housing having an aperture extending through the inner surface of the sliding door by which a latch, hingedly mounted to the aperture, can engage a catch opposite the inner surface of the door and adjacent to the doorway opening. While this device does inhibit sliding and pivoting, it cannot prevent the unlatching of the door by an intruder who has gained access through other points of entry.

U.S. Pat. No. 3,388,937 to Wirsig discloses a sliding door fastener comprising an elongated rod which longitudinally slides and rotatably projects through the door with an elongated handle radially extending from one end and an elongated latching leg radially extending from the other end. The leg and handle extend at a right angle to each other, and the fastener is limited in rotation to a half-circle whereby the handle maintains the leg in an attained locked position or unlocked position due to the offset weight thereof placing torsion on the rod. While the fastening device disclosed by Wirsig does succeed in preventing sliding or pivoting of the door about the track, it does not address the security concern of an intruder cutting the lock (padlock) which may be directed about the handle and loop to prevent releasing the fastener. The shackle of the lock disclosed by Wirsig is immediately accessible to any intruder with a set of bolt cutters or saw. The lock disclosed by Wirsig is also open to environmental elements which may render it unusable, such as when encased in ice after a snowstorm. An apparent advantage of the invention disclosed herein is that the shackle of the lock is shielded by a housing which would prevent an intruder from quickly cutting the lock and unlatching the door. Further, a cover plate may be included in the presently disclosed invention to fully protect the lock from environmental conditions.

What is desired, therefore, is a locking system for a sliding door which inhibits both the sliding travel and pivoting action of the door and prevents an intruder from unlocking the sliding door from the inside of the structure. What is further desired is a locking system with a reduced complexity of installation. It is yet a further desire that the device may be unfastened only from the exterior of the building and that the shackle of the lock be shielded from attack.

### SUMMARY OF THE INVENTION

Accordingly, it is an object of the present invention to provide a locking assembly for a barn or other sliding door.

It is another object of the invention to provide a door locking assembly that inhibits both the sliding and outward pivoting action of the door about its track.

It is another object of the invention to provide a door locking assembly which is simple, yet robust, to increase the ease of installation.

It is another object of the invention to provide a locking assembly which provides shielding for the shackle of a lock, to increase the difficulty of cutting and removing the lock.

It is still another object of the invention to provide a locking assembly which is tamper-proof from the inside of the structure to inhibit intruders from defeating the locking the system.

To overcome the deficiencies of the prior art and to achieve at least some of the objectives and advantages listed, herein is disclosed a sliding door locking system comprising a locking plate, a bracket, a lock housing, and a lock.

The locking plate is mounted to the outer surface of a sliding door, such as a barn door, so that when the door is in a closed position the locking plate is located adjacent to a side edge of the doorway opening, such as a jamb of a doorframe. A bracket is mounted to the jamb, interiorly to the sliding door, and is positioned so that a thru hole in the locking plate and a thru hole in the bracket are coaxially aligned. Each thru hole in the bracket has at least one notch cut from its perimeter acting as a keyway, and the sliding door is bored so that a shaft may pass through the locking plate, door, and bracket.

The lock housing comprises a plate from which side walls extend from the front side and a shaft extends from the back side. At least one wing extends from the distal end of the shaft so that the lock housing may be slidingly inserted through and beyond the locking plate, door, and bracket when the wing is rotatably aligned with the keyway. The lock housing may then be rotated so that the wing engages with the bracket to prevent the lock housing from moving transversely. In the rotated (engaged) configuration, a locking tab on the lock housing aligns with a locking tab on the locking plate so that a padlock may secure the lock housing in the engaged position.

Concisely, the invention described herein illustrates a sliding door locking system, comprising, consisting, and consisting essentially of a locking plate including a first thru hole and a first locking tab mounted to an outer surface of a sliding door adjacent to a first side edge of a door frame; a bracket having a base and at least one bracket side wall, said base being mounted to the first side edge of the door frame and having a second thru hole in the at least one bracket side wall, said second thru hole having at least one notch cut from the perimeter to act as a keyway, and said second thru hole of the bracket positioned to be aligned with the first thru hole of the locking plate; a lock housing including a plate, a shaft, a housing side wall, an arced-slot, and a second locking tab, said housing side wall and second tab extending from the front of the plate, said shaft extending from the back of the plate, and said arced-slot extending from a contact side of the second locking tab; wherein said shaft includes at least one wing to slidingly insert through the at least one keyway of the bracket; and a padlock having a shackle. A bore in the sliding door is aligned coaxially with the first thru hole of the locking plate and the second thru hole of the bracket to allow passing of the shaft through the door. The arced-slot of the lock housing is positioned so that, when the lock housing is in an orientation which allows for the at least one wing of the shaft to pass through the at least one keyway of the bracket and the shaft of the lock housing is inserted through the door, the first locking tab of the locking plate slidingly engages with the arced-slot. The second locking tab of the lock housing abuts the first locking tab when the lock housing is rotated to an engaged configuration so that transverse motion is prohibited due to interference between the at least one wing of the shaft and the bracket. Both the first tab and second tab have a first shackle hole and second shackle hole, respectively, through which the shackle of the padlock can be inserted simultaneously through each shackle hole to lockingly secure the system in an engaged configuration.

### BRIEF DESCRIPTION OF DRAWINGS

FIG. 1 is a cross-sectional view of a sliding door locking system in an engaged orientation according to one embodiment of the present invention;

FIG. 2 is a perspective view of a structure having a sliding door in an open configuration;

FIG. 3 is a perspective view of the structure of FIG. 2 having the sliding door in a closed configuration;

FIG. 4 is a front plan view of a locking plate according to one embodiment of the present invention;

FIG. 5 is a side plan view of the locking plate of FIG. 4;

FIG. 6 is a perspective view of the bracket according to one embodiment of the present invention;

FIG. 7 is a front plan view of the lock housing according to one embodiment of the present invention;

FIG. 8 is a side plan view of the lock housing of FIG. 7;

FIG. 9 is an exterior perspective view of the sliding door locking system of FIG. 1 in a pre-insertion configuration;

FIG. 10 is an exterior perspective view of the sliding door locking system of FIG. 1 in an inserted configuration;

FIG. 11 is an exterior perspective view of the sliding door locking system of FIG. 1 in an engaged configuration;

FIG. 12 is an interior perspective view of the sliding door locking system of FIG. 1 in an engaged configuration;

FIG. 13 is an exterior perspective view of the sliding door locking system of FIG. 1 in a locked configuration;

FIG. 14 is an exterior perspective view of an alternative embodiment of the lock housing;

FIG. 15 is an exterior perspective view of an additional alternative embodiment of the lock housing.

FIG. 16 is a front plan view of an alignment guide mounted to an interior support member according to an alternative embodiment of the lock housing.

FIG. 17 is a side cross-sectional view of the alignment guide of FIG. 16.

FIG. 18 is an exploded view of the alignment guide of the embodiment of FIG. 16.

FIG. 19 is a front plan view of an alternative embodiment of an alignment guide.

FIG. 20 is a top view of a preferred embodiment of the lock housing with the lock inserted.

FIG. 21 is a side view of the lock housing in FIG. 20 with the lock inserted.

### DETAILED DESCRIPTION OF THE INVENTION

Various embodiments of the present invention are described herein and depicted in the drawings. To acquaint persons skilled in the pertinent arts most closely related to the present invention, a preferred embodiment that illustrates the best mode now contemplated for putting the invention into practice is described herein by, and with reference to, the annexed drawings that form a part of the specification. This exemplary embodiment is described in detail without attempting to describe all the various forms and modifications in which the invention might be embodied. As such, the embodiments described herein are illustrative and, as will become apparent to those skilled in the arts, may be modified in numerous ways within the scope and spirit of the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature structure, or characteristic in connection with other embodiments, whether or not explicitly described.

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” or “an”, “one or more” and “at least one” can be used interchangeably herein.

The use of “including,” “comprising,” or “having,” and variations thereof herein is meant to encompass the items listed thereafter and equivalents thereof as well as additional items. Accordingly, the terms “including,” “comprising,” or “having,” and variations thereof can be used interchangeably herein.

It shall be understood that the terms “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

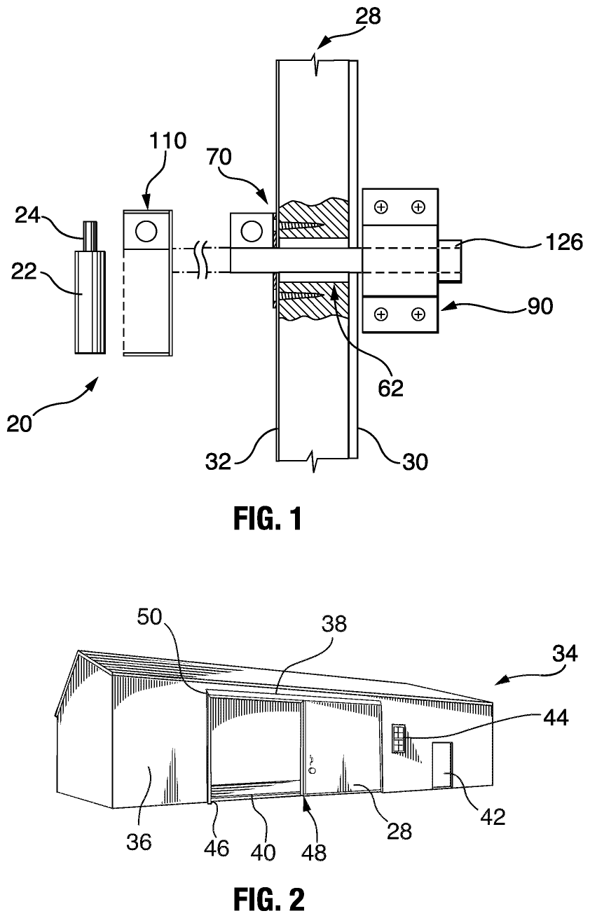

Referring now to FIG. 1, a sliding door 28, such as a barn door, in a closed configuration and a sliding door locking system 20 of one embodiment of the present invention is illustrated in a side cross sectional view. The sliding door 28 has an inner surface 30 and an outer surface 32. The sliding door locking system comprises, consists of, and consists essentially of four primary components which will be described in further detail below: a lock plate 70, bracket 90, a lock housing 110, and a padlock 22.

As shown in FIG. 2, the sliding door 28 is surface mounted to an existing structure 34, such as a standard exterior wall 36, typically by hanging the door from a track 38 mounted above a doorframe 50. The sliding door 28 can move along the track 38 via sliders, wheels, or other sliding mechanisms. The sliding door 28 of FIG. 2 is shown in its open configuration whereby access to the contents of the structure 34 can be easily accessed through the doorway opening 40—especially large items which could not be moved through a standard access door 42 or a window 44. The doorway opening 40 has a first jamb 46 and a second jamb 48 of the doorframe 50. In alternative embodiments, the sides of the doorway may be defined by the end of another sliding door.

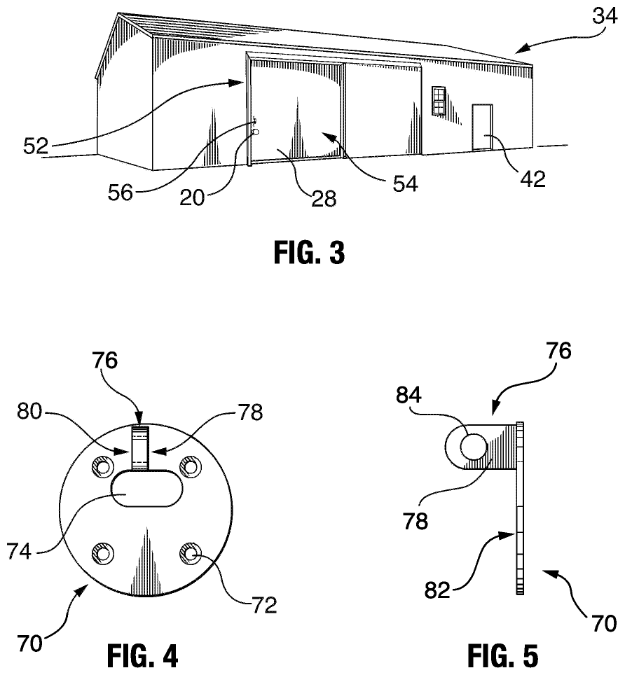

The sliding door 28 slides back and forth along the track 38, such that the inner surface 30 slides over the doorway opening 40. The door is closed when the leading edge 52 and the trailing edge 32 of the sliding door 28 overlap the first jamb 46 and the second jamb 48, respectively, of the doorway opening 40, as shown in FIG. 3. In some embodiments, a handle 56 is provided on one or both of the inner surface 30 and outer surface 32 for sliding the door 28 open and closed. Once the sliding door 28 is closed, the door locking system 20 is employed to secure the door in this position.

Referring now to FIGS. 4 and 5, a lock plate 70 having at least one but preferably multiple mounting holes 72 is mounted to the outer surface 32 of the sliding door 28 using a mechanical fastener such as nails or screws. The lock plate 70 includes a thru hole 74 horizontally centered on the plate. A first tab 76 having a first contact side 78 and a first opposing side 80 extends from the front face 82 of the lock plate 70, so that the first contact side 78 of the first tab 76 is aligned vertically with the center of the thru hole 74. The first tab 76 has a first shackle hole 84 perpendicular to its extension, with a diameter sufficient for engaging the shackle 24 of a padlock 22.

The lock plate 70 is positioned on the outer surface 32 of the sliding door 28 so that the lock plate overlaps an interior support member 58 (reference FIG. 12) of the sliding door 28, to ensure the fasteners securely engage with the door. The interior support member 58, and any exterior siding 60 of the sliding door 28, includes a bore 62 drilled, milled, or cut to align with, and provide at least as much clearance, as the thru hole 74 of the lock plate 70. A further requirement for the positioning of the lock plate 70 is that the plate must be positioned so that, when the sliding door is in the closed position, the plate is adjacent to either the first jamb 46 or the second jamb 48 of the doorway opening 40. In the illustrated embodiment, the plate is positioned adjacent to first jamb 46 of the doorframe 50.

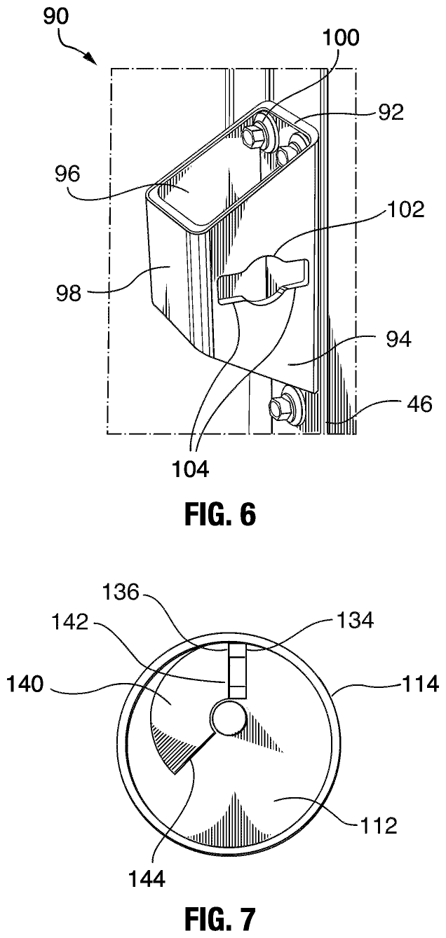

A bracket 90 having a base 92, a first side wall 94 extending perpendicularly from the base 92, a second side wall 96 extending perpendicularly from the base 92 offset from the first side wall 94, and an outer wall 98 connecting the first and second sidewalls at their distal ends is illustrated in FIG. 6. At least one but preferably multiple mounting holes 100 are located near the outer edges of the base 92 of the bracket 90. The first side wall 94 and the second side wall 96 are chamfered to allow tools to access the mounting holes 100 so that the bracket can be fastened to the first jamb 46 of the doorframe 50 using mechanical fasteners such as nails, screws, or bolts. The first side wall 94 and the second side wall 96 include a thru hole 102 which has at least one notch at its perimeter to act as a keyway 104. The bracket 90 is positioned on the jamb 46 so that the bracket thru hole 102 aligns with the lock plate thru hole 74, and that the first side wall 94 of the bracket 90 is parallel to the inner surface 30 of the sliding door 28.

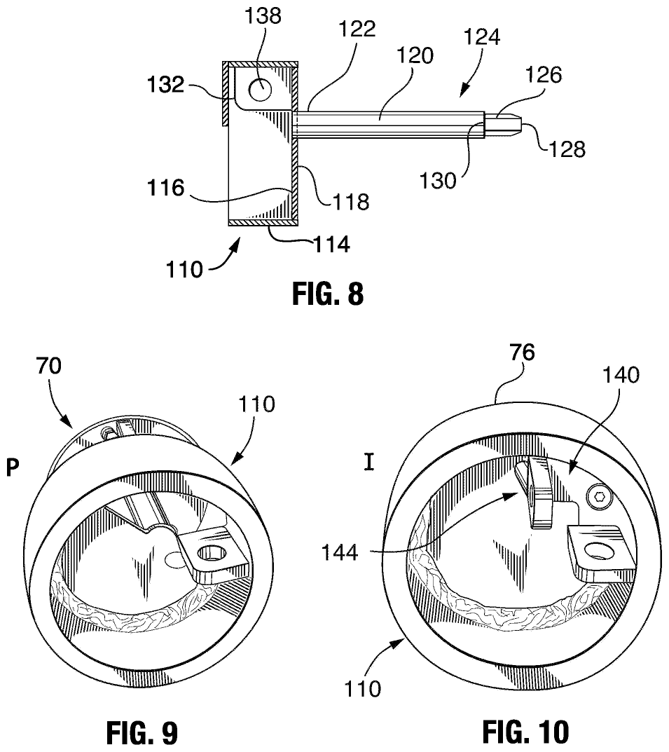

FIGS. 7 and 8 illustrate a lock housing 110 having a plate 112 and side walls 114, the plate 112 having a front surface 116 and a back surface 118, where the side walls 114 extend from the front surface 116 of the plate 112. A shaft 120, having a proximal end 122 and a distal end 124, extends from the back surface 118 of the plate 112, horizontally centered. At least one wing 126 extends outward from the distal end 124 of the shaft 120. The size and shape of the wing 126 is such that it may slidingly fit through the keyway 104 of the thru hole 102 of the bracket 90 only when the lock housing 110 is in an unengaged orientation. The wing 126 has a leading side 128 and an engagement side 130. In the present embodiment, the lock housing has two opposing wings which coordinate with two opposing keyways. It would be appreciated by one skilled in the art that there be any combination of wings and respective keyways, given that there is at least one keyway for each wing.

A second tab 132, having a second contact side 134 and a second opposing side 136, extends inwards from a section of the sidewalls 114 and the front surface 116 of the plate 112 so that the contact side 134 of the second tab 132 is aligned vertically with the center of the shaft 120. The second tab 132 includes a second shackle hole 138 perpendicular to its inward extension, with a diameter sufficient for engaging the shackle 24 of a padlock 22.

The plate 112 includes an arced-slot 140 which is concentric with the shaft 120 and is sufficiently wide to slidingly engage with the first tab 76 of the lock plate 70. The arced-slot 140 has a first end 142 and a second end 144, where the first end 142 is flush with the contact side 134 of the second tab 132 and the second end 144 terminates at an angle sufficient to allow the first tab 76 of the lock plate 70 to be inserted into the lock housing 110 when the lock housing is oriented in a pre-insertion configuration, to be further discussed. It will become apparent to one who is skilled in the art that the preferred termination arc angle is dependent upon the orientation of the keyway with respect to the locking tab. In the illustrated embodiment, the termination angle is about 120 degrees.

Referring now to FIG. 9, a lock housing 110 is shown in a pre-insertion configuration P, where the lock housing is, in the illustrated embodiment, rotated 90 degrees clockwise so that the wings 126 of the shaft 120 may slidingly fit through the thru hole 74 of the lock plate 70, the bore 62 of the sliding door 28, and the thru hole 102 of the bracket 90.

FIG. 10 illustrates the lock housing 110 in an inserted configuration I, where the shaft 120 of the pre-inserted lock housing has been inserted through the lock plate 70, the bore 62, and the bracket 90 so that the back surface 118 of the lock housing 110 is flush with the front face 82 of the lock plate 70, and the engagement side 130 of the wings 126 of the shaft 120 extend past the second side wall 96 of the bracket 90. The first tab 76 of the lock plate 70 passes through the arced-slot 140 of the lock housing 110 proximate to the second end 144 of the slot. The inserted configuration I of the door locking system 20 prevents the sliding door 28 from traversing the track 38.

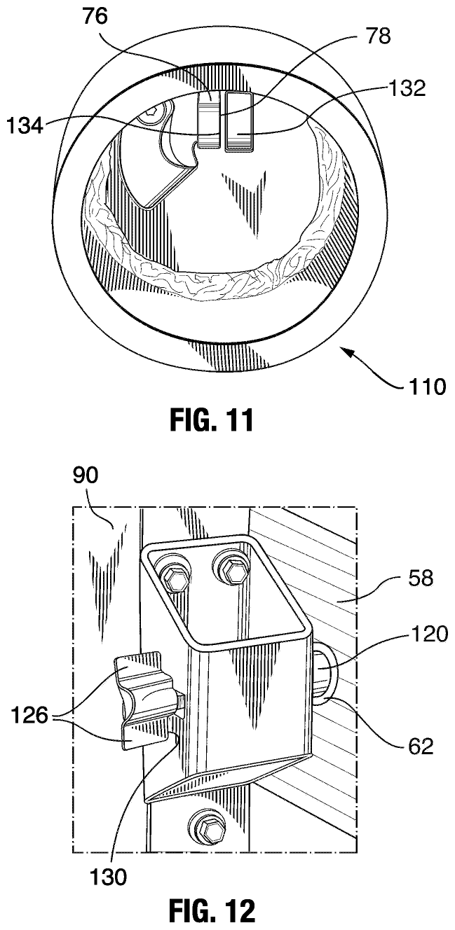

FIGS. 11 and 12 illustrate the lock housing 110 in an engaged configuration E, where the inserted lock housing has been turned counterclockwise 90 degrees so that the second contact side 134 of the second tab 132 of the lock housing 110 is coincident with the first contact side 78 of the first tab 76 of the lock plate 70. In the engaged configuration E, the wings 126 of the shaft 120 extend beyond the perimeter of the bracket thru hole 102 so that if extraction of the lock housing 110 is attempted the engagement side 130 of the wings 126 interfere with the bracket 90, thereby preventing the lock housing from being removed. The engaged configuration E of the door locking system 20 further prevents the sliding door 28 from pivoting away from the exterior wall 36 of the structure 34.

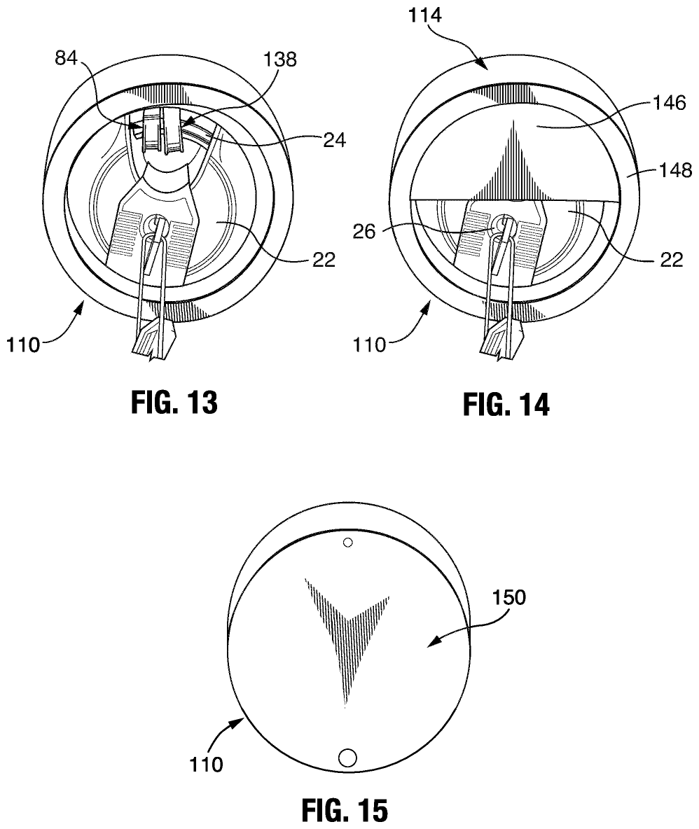

A locked configuration L of the door locking system 20 is illustrated in FIG. 13. In an engaged configuration E, the first shackle hole 84 of the first tab 76 of the lock plate 70 is aligned with the second shackle hole 138 of the second tab 132 of the lock housing 110 so that the shackle 24 of a padlock 22 may simultaneously pass through each shackle hole. The padlock 22 is designed such that the shackle 24 prohibits the lock housing 110 from being disengaged by unwanted persons.

In an alternative embodiment, illustrated in FIG. 14, the lock housing 110 further comprises a cover plate 146 affixed to the front-facing edges 148 of the side walls 114 of the lock housing. The cover plate 146 conceals a portion of the front of the lock housing 110 so that when the padlock 22 is inserted into the lock housing only the keyhole 26 of the padlock 22 is exposed while the shackle 24 of the padlock 22 is protected from an attacker attempting to cut the shackle.

In an alternative embodiment, illustrated in FIG. 15, the lock housing 110 further comprises a decorative cover 150 hingedly or slidingly mounted to the front-facing edges 148 of the side walls 114 of the lock housing. The decorative cover 150 protects the padlock 22 from inclement weather conditions and may be painted to make the sliding door locking system more conspicuous.

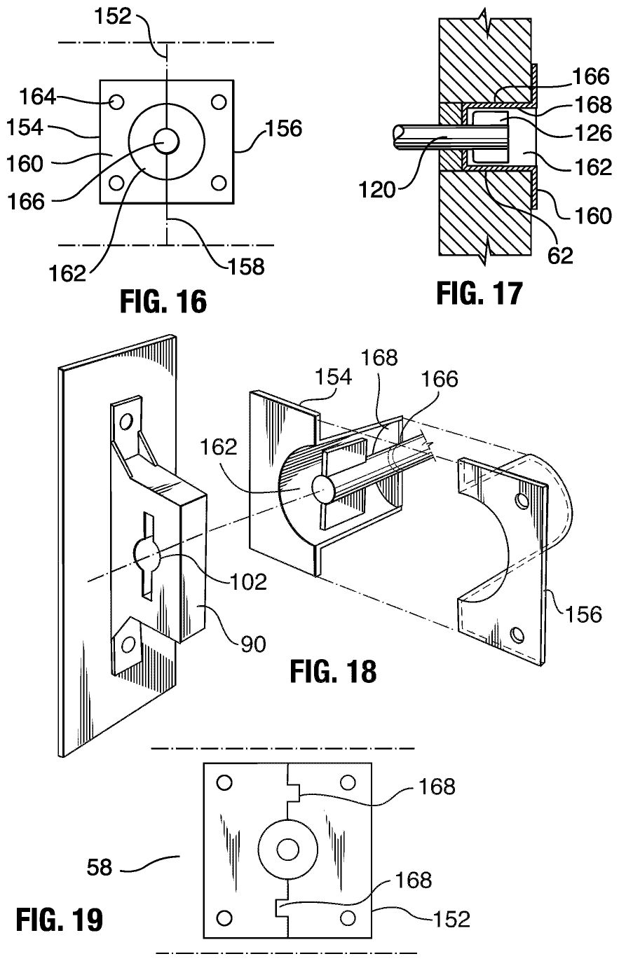

In a further alternative embodiment, illustrated in FIGS. 16-18, an alignment guide 152 is mounted to the interior support member 58 on the inner surface 30 of the sliding door 28. The function of the alignment guide 152 is to reduce the clearance between the shaft 120 of the lock housing 110 and the bore 62 of the sliding door 28, thereby assisting the user in accurately inserting the shaft through the bore and, ultimately, the thru hole 102 of the bracket 90. Because the alignment guide 152 will prevent the lock housing from being completely removed from the sliding door, it is necessary to include a pocketed region for the wings of the shaft to withdraw into during disengagement of the door locking system 20 so that the shaft does not interfere with the sliding door traversing its track 38. The alignment guide 152 comprises two, preferably symmetrical, halves-a left alignment plate 154 and a right alignment plate 156, respectively. The parting line 158 of the left and right alignment plates is coincident with the centerline of the bore 62. A detailed description of the left alignment plate 154 will now be given with an understanding that the right alignment plate 156 is mirrored about the parting line 158.

The left alignment plate 154 comprises a base 160, a recessed pocket 162, and at least one mounting hole 164. The recessed pocket 162 is preferably semicircular with its origin centered on the parting line 158; having an outer radius 166 which is sized to fit within the bore 62, and an inner radius 168 which is sufficiently large that the at least one wing 126 of the shaft 120 fits within the pocketed area. The recessed pocket 162 has a depth sufficient that the at least one wing 126 of the shaft 120 can be withdrawn into the pocket so that it does not interfere with the traversing of the sliding door 28 along the track 38 upon disengagement of the door locking system. Further, the recessed pocket 162 includes a semicircular cutout 166 in the floor of the pocket 162, coaxial with the bore 62, which is appropriately sized to provide a locational fit for the shaft 120 when used in tandem with the right alignment plate 156. The at least one mounting hole 164 is positioned radially outward of the recessed pocket so that the alignment plate may be fastened to the interior support member 58.

Prior to installation of the bracket 90, the shaft 120 of the lock housing 110 is fully inserted through the bore 62 of the sliding door 28. The left alignment plate 154 and the right alignment plate 156 can then be inserted into the bore 62, around the shaft 120, and mounted to the interior support member 58. To ensure the two halves of the alignment guide 152 are properly aligned with one another, in an alternative embodiment the left alignment plate 154 and the right alignment plate 156 may further include interlocking fingers 168, as illustrated in FIG. 19. The alignment guide may be made of a metal or a polymer, especially of the self-lubricating variety.

To reduce the complexity of manufacturing and installation, while maintaining an acceptable clearance between the shaft 120 of the lock housing 110 and the bore 62 of the sliding door 28, a preferred embodiment of the door locking system 101 will now be discussed.

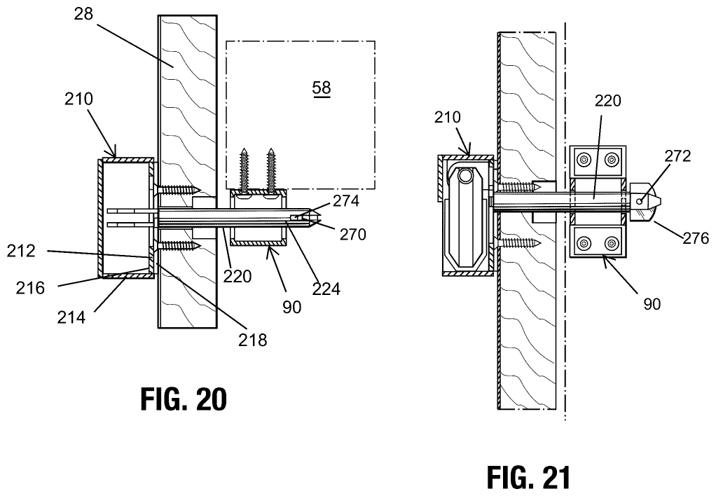

FIG. 20 illustrates a preferred lock housing 210 having a plate 212 and side walls 214, the plate 212 having a front surface 216 and a back surface 218, where the side walls 214 extend from the front surface 216 of the plate 212. A shaft 220, having a proximal end 222 and a distal end 224, extends from the back surface 218 of the plate 212, horizontally centered. The distal end 224 of the shaft 220 has a thru-hole 270, which is formed perpendicular to the axis of the shaft, meant to receive a dowel pin 272 after having been inserted through the thru-hole 74 of the lock plate 70, the bore 62 of the sliding door 28, and the bracket 90. The length of the dowel pin 272 is greater than the diameter of the shaft 220 so that, after it is fitted into the thru-hole 270 of the shaft, it effectively acts as a wing 126, as described previously. The dowel pin 272 and thru-hole 270 are sized so that the dowel pin is press-fit into the thru-hole, thereby preventing removal without an appropriately sized punch. Manufacturing the lock housing 210 to receive the dowel pin 272 after initial insertion eliminates the need to oversize the thru-hole 74 of the lock plate 70 and the bore 62 of the sliding door 28 to accommodate for the wings 126 of the shaft 120 which were integrally formed in the previous embodiments.

In an alternative embodiment, illustrated in FIG. 21, a notch 274 is made in the distal end 224 of the shaft 220 perpendicular to the thru-hole 270. A wing plate 276 having a thru-hole 278 centered on the plate can be inserted into the notch 274 and secured by the dowel pin 272. The plate need not be planar but may extend from the sides of the shaft in any geometry which is similar to that of the keyway 104 of the bracket 90.

In an alternative embodiment, a gripping-aperture may be attached to, or formed in, the side walls 114 of the lock housing 110 to assist in rotating, inserting, or extracting the lock housing. The gripping-aperture may be selected from the group consisting of a lever, a knob, a hook, a handle, an indent, a hole, and any other suitable device that can be grabbed or grasped by a user to pull, push, or rotate the lock housing 110.

In a further alternative embodiment, the side walls 114 of the lock housing 110 may have a surface treatment such as knurling, sandblasting, shot peening, or a rubberized coating to assist the user in maintaining a good grip on the lock housing.

In an alternative embodiment, the bracket is configured to have only one side wall having a thru hole. The bracket may be readily manufactured from modified “L-shaped” steel angle, “C-shaped” steel channels, or steel square tubing.

In an alternative embodiment, the fastening elements used to mount the lock plate and the bracket may be of the tamper-proof variety to prevent unwanted persons from removing the locking system.

In an alternative embodiment, the shaft is configured to have a plurality of wings and the keyways are cut accordingly so that when the lock housing is rotated to an engagement position the engagement side of the wings will interfere with the bracket to prevent the lock housing from being extracted. One having skill in the art may envision other shapes for the wings to achieve an interference effect upon rotation, such as semicircular or triangular.

In all the embodiments described herein, metal is the preferred primary material for manufacturing the lock housing 110, the lock plate 70 and the bracket 90. The components may be produced from additive manufacturing methods such as selective laser sintering, subtractive manufacturing methods such as milling and turning, or molding methods such as casting.

It is appreciated that certain features of the invention, which are, for clarity, described in the context of separate embodiments, may also be provided in combination in a single embodiment. Conversely, various features of the invention that are, for brevity, described in the context of a single embodiment, may also be provided separately or in any sub-combination.

What is claimed is:

1. A sliding door locking system, comprising:
a locking plate including a first thru hole and first locking tab mounted to an outer surface of a sliding door adjacent to a first side edge of a door frame;
a bracket having a base and at least one bracket side wall, said base being mounted to the first side edge of the door frame and having a second thru hole in the at least one bracket side wall, said second thru hole having at least one notch cut from the perimeter to act as a keyway, and said second thru hole of the bracket positioned to be aligned with the first thru hole of the locking plate;
a lock housing including a plate, a shaft, a housing side wall, an arced-slot, and a second locking tab, said housing side wall and second tab extending from the front of the plate, said shaft extending from the back of the plate, and said arced-slot extending from a contact side of the second locking tab;
wherein said shaft includes at least one wing to slidingly insert through the at least one keyway of the bracket;
and a padlock having a shackle;
said arced-slot of the lock housing positioned so that, when the lock housing is in an orientation which allows for the at least one wing of the shaft to pass through the at least one keyway of the bracket, the first locking tab of the locking plate slidingly engages with the arced-slot when the shaft of the lock housing is inserted through the first thru hole of the locking plate, a bore in the sliding door aligned with the first thru hole of the locking plate, and the second thru hole of the bracket;
said second locking tab of the lock housing abutting the first locking tab when the lock housing is in an engaged configuration by rotating the lock housing so that transverse motion is prohibited due to interference between the at least one wing of the shaft and the bracket;
and both the first and second tab having a first shackle hole and second shackle hole, respectively, through which the shackle of the padlock can be inserted simultaneously through each shackle hole to lockingly secure the system in an engaged configuration.

2. The sliding door locking system of claim 1 wherein the at least one wing of the shaft is integrally formed with the shaft.

3. The sliding door locking system of claim 1 wherein the distal end of the shaft contains a thru-hole perpendicular to the axis of the shaft for receiving a dowel pin after an initial insertion of the shaft through the bracket, where said dowel pin acts as the at least one wing of the shaft.

4. The sliding door locking system of claim 1 wherein the distal end of the shaft contains a thru-hole perpendicular to the axis of the shaft for receiving a dowel pin after initial insertion of the shaft through the bracket, and a notch perpendicular to said thru-hole of the shaft, whereby a wing plate may be inserted into said notch and is secured to said shaft by said dowel pin.

5. The sliding door locking system of claim 1 wherein the shaft has two opposing wings, said wings aligning with at least to two opposing keyways notched into the perimeter of the thru-hole of the bracket.

6. The sliding door locking system of claim 1 further comprising a cover plate affixed to front facing edges of the side wall of the lock housing to prevent access to the shackle of the padlock.

7. The sliding door locking system of claim 1 further comprising a decorative cover hingedly or slidingly mounted to the front facing edges of the side wall of the lock housing to protect the padlock from inclement weather.

8. The sliding door locking system of claim 1 further comprising a gripping-aperture attached to, or formed in, the side wall of the lock housing selected from the group consisting of a lever, a knob, a hook, a handle, an indent, and a hole.

9. The sliding door locking system of claim 1 further comprising a grip-promoting surface treatment on the exterior of the lock housing selected from the group consisting of knurling, sandblasting, shot peening, and rubber coating.

10. The sliding door locking system of claim 1 wherein the bracket has at least two side walls.

11. The sliding door locking system of claim 1 wherein a first side of the arced-slot terminates at least 15 degrees, preferably 45 degrees, and more preferably 90 degrees from a second side of the arced-slot.

12. The sliding door locking system of claim 1 further comprising an alignment guide to provide a locational fit for the shaft of the lock housing within the bore of the sliding door.

13. The sliding door locking system of claim 12 wherein the alignment guide comprises a left alignment plate and a right alignment plate having interlocking fingers for increased alignment during installation.

14. A method of securing a sliding door from travelling along a track or pivoting outwardly from the exterior of a building, comprising:
providing a sliding door locking system, comprising:
a locking plate including a first thru hole and first locking tab mounted to an outer surface of a sliding door adjacent to a first side edge of a door frame;
a bracket having a base and at least one bracket side wall, said base being mounted to the first side edge of the door frame and having a second thru hole in the at least one bracket side wall, said second thru hole having at least one notch cut from the perimeter to act as a keyway, and said second thru hole of the bracket positioned to be aligned with the first thru hole of the locking plate;
a lock housing including a plate, a shaft, a housing side wall, an arced-slot, and a second locking tab, said housing side wall and second tab extending from the front of the plate, said shaft extending from the back of the plate, and said arced-slot extending from a contact side of the second locking tab;
wherein said shaft includes at least one wing to slidingly insert through the at least one keyway of the bracket;
and a padlock having a shackle;
rotationally aligning said lock housing so that the at least one wing of the shaft aligns with the at least one keyway of the bracket;
inserting said shaft of the lock housing through the thru hole of the locking plate, a bore in the sliding door aligned with the thru-hole of the locking plate, and the thru-hole of the bracket;
rotationally engaging the locking system by rotating the lock housing to prevent extraction of the lock housing due to interference between the at least one wing of the shaft and the bracket, wherein the rotation also abuts the first locking tab of the locking plate with the second locking tab of the lock housing so that a shackle hole in each of the locking tabs are aligned;
and lockingly securing the system by inserting a shackle of a padlock through the first shackle hole in the first tab and the second shackle hole in the second tab.
